(19) United States
(12) Patent Application Publication
(10) Pub. No.: US 2006/0211363 A1
(43) Pub. Date: Sep. 21, 2006

(54) Fire protection : air escape vent

(76) Inventor: John Richard Coxon, Pulborough (GB)

Correspondence Address: JOHN RICHARD COXON, SOUTH GORINGLEE FARM HOUSE, HARBOLETS RD., WEST CHILTINGTON, PULBOROUGH, WEST SUSSEX, GB

(21) Appl. No.: 11/356,852

(22) Filed: Feb. 21, 2006

(30) Foreign Application Priority Data
Mar. 7, 2005 (GB) 0504616.4

(51) Int. Cl. E06B 7/02

(52) U.S. Cl. 454/227

(57) ABSTRACT

An air escape vent with a balanced louvre to allow air to escape rapidly after a minimum air pressure is reached.

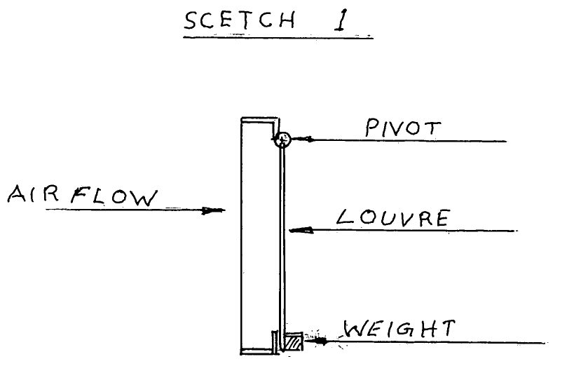

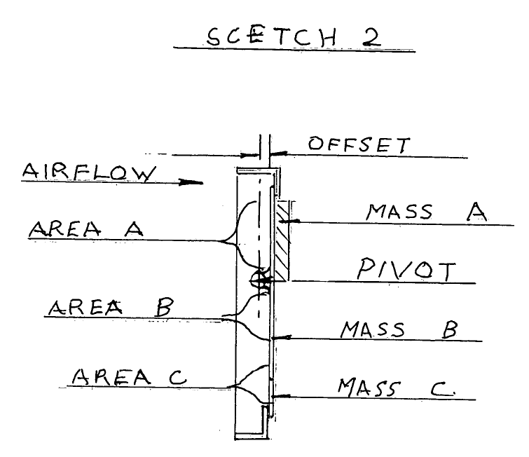

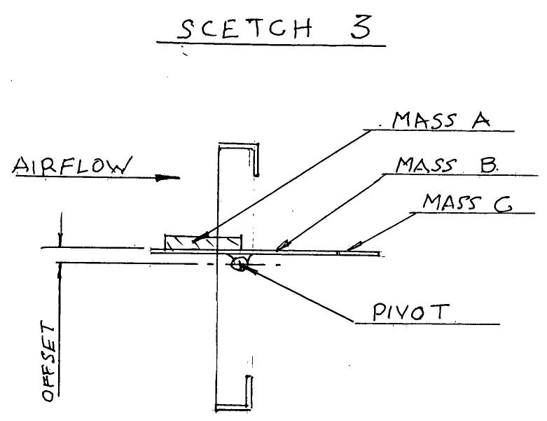

When a fire breaks out in a house or factory, the normal procedure is to spray water on the fire. In the modern world the spraying of water has been superseded by using an inert gas to replace the water. To accomplish this it is necessary to replace more than half the volume of air in the house or factory space with the inert gas. Cylinders of inert gas or modified air must replace over half the volume of the room in which the fire is present. To accomplish this it is required to provide an escape valve for the existing air in the room to be exhausted and replaced. The present methods is to make an exhaust valve in the form of a panel of louvres hinged to allow the air to escape and weighted to close after the air has passed through. This method has the disadvantage, that the louvre will open very easily to start with, but will not open fully when the airflow increases. It would be advantageous if a louvred valve resisted opening until a minimum pressure was achieved, and then open easily until fully opened and the pressure drops.

According to the present invention, an escape valve in the form of one or more louvres set in a frame shall be caused to open when the minimum pressure is achieved. Thereafter the louvres will open to their maximum until the flow rate of air reduces below a minimum valve.

The invention will now be described in detail with the help of the enclosed sketches.

Sketch 1. Shows the present type of vent.

Sketch 2. Shows a single louvre closed.

Sketch 3. Shows the louvre in the open condition.

When the pressure of air is applied to the louvre in sketch 2, the pressure of air is pushing the above area A, which is balanced against the area below B, and only area C pushes the louvre open due to the total mass or weight of the louvre being behind the pivot. The weight of the louvre exceeds the pressure of the combined area of the louvre until the pressure exceeds the opposing weight of the louvre. Once the pressure has exceeded the minimum opening pressure the louvre will open. When the louvre has started to open then the weight of mass A will rotate around the pivot and reduce the pressure required to fully open the louvre. When the louvre is fully open its pressure required for it to remain open is low. Once the airflow reduces below a certain rate the louvre will close and remain closed until the pressure increases above the minimum opening pressure.

1. A louvre vent with offset pivot in front of the louvre in the direction of the airflow.

2. A louvre vent with a heavy portion above the pivot line to balance most of the lower part of the louvre when open.
